(19) United States
(12) Patent Application Publication
(10) Pub. No.: US 2007/0283317 A1
(43) Pub. Date: Dec. 6, 2007

(54) Inter domain services manager

(75) Inventors: William E. Sadler, Sharpsburg, GA (US); Stephen M. Hart, Marietta, GA (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(73) Assignee: Organizational Strategies, Inc., Arlington, VA (US)

(21) Appl. No.: 11/717,412

(22) Filed: Mar. 13, 2007

Related U.S. Application Data
(60) Provisional application No. 60/783,541, filed on Mar. 17, 2006.

(51) Int. Cl. G06F 9/44

(52) U.S. Cl. 717/103

(57) ABSTRACT

The integration of a myriad of modern and legacy systems into a unified logical view is provided. Modern software systems are dependent upon the interaction with and extraction of data from a multitude of distributed systems each generally being accessed by unique credentials using proprietary or vendor-specific protocols. Users faced with the extraction and manipulation of data from these disparate sources must manage multiple login accounts, simultaneously run multiple applications for access and manipulation of data from said sources, and develop new or utilize existing tools for correlation and reporting of data. The present invention provides a single-point interface through which multiple, disparate systems interoperate. User security, communications, information management, searching, reporting, logging, and system maintenance can be performed on any of these systems from a single point provided by this invention. In short, this invention allows users to present a tailored view or representation of the underlying systems it integrates, and is built upon an extensible framework that facilitates rapid deployment of new or changes to the existing subsystems it integrates. The IDSM Processor framework provides XML-based interaction with IDSM clients, validation of client-supplied messages, IDSM data store access, and the management of process flow through the system including identification and invocation of versioned service processing logic. Service processing logic is necessarily dependent upon the requirements associated with said service; therefore, design and implementation details are outside the context of this framework document and will be included in service-specific artifacts.

### CROSS REFERENCE TO RELATED APPLICATION

This application is based upon and claims benefit of copending and co-owned U.S. Provisional Patent Application Ser. No. 60/783,541 entitled “Inter Domain Services Manager”, filed with the U.S. Patent and Trademark Office on Mar. 17, 2006, the specification of which is incorporated herein by reference.

### GOVERNMENT LICENSE RIGHTS

This invention was made with Government support under contract number N-68335-05-D0010 awarded by the Department of Defense. The Government has certain rights in the invention.

### BACKGROUND OF THE INVENTION

1. Field of the Invention

The present invention relates to computer systems and in particular to a system and method to provides the integration of a myriad of modern and legacy systems into a unified logical view.

2. Description of the Background

Modern software systems are dependent upon the interaction with and extraction of data from a multitude of distributed systems each generally being accessed by unique credentials using proprietary or vendor-specific protocols. Users faced with the extraction and manipulation of data from these disparate sources must manage multiple login accounts, simultaneously run multiple applications for access and manipulation of data from said sources, and develop new or utilize existing tools for correlation and reporting of data.

### SUMMARY OF THE INVENTION

The present invention provides a single-point interface through which multiple, disparate systems interoperate. User security, communications, information management, searching, reporting, logging, and system maintenance can be performed on any of these systems from a single point provided by this invention. In short, this invention allows users to present a tailored view or representation of the underlying systems it integrates, and is built upon an extensible framework that facilitates rapid deployment of new or changes to the existing subsystems it integrates.

Using existing methodology, technology, design, and programming capabilities, the present invention enables an enterprise-level, web-based, software solution that allows users to access, edit, and combine information created and stored in varied and often diverse information repositories. In a preferred embodiment, the invention is an open-source, open-architecture system operating on standard servers. It is a server side application using various enterprise interface techniques.
From a user's perspective, a single login using a standard web-browser can provide access to all of the information required to accomplish a defined task.
From an organization's perspective, the invention can:
   simplify data access and data security issues;
   provide tools to enhance collaborative project development;
   provide a consistent, customized interface to users so that less training is required; and
   provide a means to access distributed data for without interfering with existing data structures or processes.
From a developers perspective the invention can provide a well documented “core functionality” layer to
   speed development cycles by providing iterative development framework;
   ease program maintenance through adherence to defined processes and coding standards;
   provide multiple client interfaces (web services, web dav, Java, RMI, JMS, etc); and,
   provide multiple data source interface capabilities (screen scraping, ODBC, JDBC, JCA, etc.).

In one aspect of the invention, a single login using a standard web browser is all that is required for users to access information through the system. All program development and maintenance can be done from the server side, eliminating the need for specialized software or modifications to a user's computer.

FIG. 1 is block diagram showing component relationships in accordance with an exemplary embodiment of the present invention. The system application described herein uses a web services-based interface to validate users and connect them with their resources. These resources consist of information extracted from varied and diverse information repositories typically located in multiple departments and divisions across an enterprise. These repositories may reside in collections of word processor documents (e.g., Word), sophisticated relational databases (i.e., ORACLE, MySQL, SQL Server), document management systems (e.g., Documentum), flat-file databases, and even information “scraped” from the screen by the application interacting with the system as a normal user.

The system application can have robust search capabilities extending from simple word searches to sophisticated meta data searches that return highly targeted information. The ability of this application to connect disparate information sources makes it an extremely powerful tool for a broad range of business activities. In a real-world application, all of this data could be coming from different sources located on different servers throughout the organization.

Furthermore, the present invention includes several core functions that can be customized by an administrator through a simple application. An administrator can manipulate most of these functions (other than adding functionality) without any programming experience:
User Management (create, update and delete users)
Security Management (defining and assigning users to roles)
Service Management
   Process Node Creation (business logic)
   Process Pathway Management (business logic interaction)
Subscription Management which manages client subscriptions (user access to particular modules)

In another aspect of the invention, three areas of the system application can be customized for each Customer's installation. These require creation of server side Java Objects according to program specifications.
Client Interfaces other than web services, XML or JMS
Federated View Creation which customizes the users interaction with the Application by creating a single logical view of an aggregate of data sources; and
Customization of combined Application that step outside of the portal/web/portlet model

Finally, the system application enabled by the present invention can have several platform functions that provide security, operability, and ease of update/configuration.

The system can be used as a tool, and as with any tool, it only becomes useful when it is applied to reach a specific solution. The principal benefit stems from the application's ability to enable customers to search, access, and organize information from varied and diverse repositories. All levels of decision-makers, quality improvement teams, specialists, manager's and students, as well as others, can benefit from real-time access to critical information residing in other functional areas' repositories. The integration of a user's directives, handbooks, and other policy documents requires addressing the content and/or product specifications, interconnectivity, standards, and concurrency management for each product. In addition, each of these products needs to be customized to the needs of the user and integrated into the culture. The ability to support document integration and accessibility, by providing access to various repositories, could improve quality and reduce cost.

One typical problem is that meta-data is defined, but there does not exist a simple interface to access the information so it cannot be fully leveraged. A solution, according to the present invention is to provide each user or set of users with a customized interface to access, use, and/or modify template or policy documentation content.

Typical uses for this tool include:
Coordinator: find and retrieve Verified, Validated & Accredited (VV&A) resources to meet a specific need.
Producer/Developer: look for and subsequently retrieve resources on a certain topic or subject domain by entering key words or other search criteria.
Producer/Developer: store newly developed resources in a repository that is part of a system of repositories; find and retrieve different types of resources stored in different types of repositories across the repository system.

The ability to provide a single access point to improve information transfer and workflow improves both personal effectiveness and operational effectiveness. The Application's framework can be used to provide a number of resources to support program management.

Another problem is that customer's workflow and output could be enhanced with a website/portal to share information. According to the present invention, the application's portals can be used to schedule events, share documents (with revision history), post schedules, and track milestones.

Yet another problem is that customer's use a database to gather and store program requirements so that they may be prioritized and funded. Optimally, the database fields are accessed and populated by all project stakeholders (who would need varying levels of access based on needs.) According to the present invention, customized interfaces can be created to support customer functions by providing appropriate security and access to customer databases. Data is kept up to date without the need of e-mails requesting updated information. In addition, users view selected information to provide input concerning the priority of projects.

This invention can provide authoring tools that integrate data drawn from various sources. This can improve the interaction of developers and subject matter experts.

There is a constant give and take between the need to maintain “approved documents” and the need to provide more detailed information for the users. Users often want to maintain control of the “detail” level so that they can respond more quickly to training demands. On the other hand, an “approved” level must remain fixed to ensure program continuity. For example, Program directives refine the information from the Department Management Directive. The requirements from the Department's Directive are “approved” and must be tracked in the database. The database may also include the content of the Policies, Handbooks and other regulatory documentation. During the development process, it may be more efficient for the users to update portions of these regulations or guides. The problem then, is how to track concurrency with rest of curriculum.

According to the present invention, the application's framework can be used to create a collaborative authoring tool that defines a structure for the documentation or handbook and pull the high-level information from the database, and then provides the user with the ability to fill in the details. Once content is entered, it can then be pulled back into the database.

Additionally, getting the most current documents and information to a user is one of the biggest challenges of a paper or distributed electronic system. For the Warfighter, this is critical.

A solution enabled by the present invention allows the combination of this application, a structured document system, and a process to identify user attributes and authorization to give any customer access to the information they need through centralized secure access. The access can be controlled at the local level through a centralized database that points to the documents and information in their “home” location and then consolidates them for the user.

In addition, documents and data can easily be reformatted to be hosted on a variety of displays and PDA type devices. This provides an increased ability to access the full array of information while deployed.

The application for the system described herein runs on standard servers operating in a J2EE environment; the software is based on open architecture, open-source coding. While the application can provide a highly agile and sophisticated product, its underpinnings are designed to reduce the complexity of installation, operation, and maintenance.

In addition, the system is designed to be rapidly reconfigured to accept new data sources, principally through configuration rather than complex programming. This ensures rapid deployment of new services and reduces cost of bringing those services on line.

The various features of novelty that characterize the invention will be pointed out with particularity in the claims of this application.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is block diagram showing component relationships in accordance with an exemplary embodiment of the present invention;

FIG. 2 is a Processor Framework Collaboration Diagram according to an embodiment of the present invention;

FIG. 3 is a Deployment Diagram according to an embodiment of the present invention;

FIG. 4 is a Request Validation Class Diagram according to an embodiment of the present invention;

FIG. 5 is a Process Component Class Diagram according to an embodiment of the present invention;

FIG. 6 is a Logging Component Class Diagram according to an embodiment of the present invention;

FIG. 7 is an IDSMRequest Message Class Diagram according to an embodiment of the present invention;

FIG. 8 is an IDSMResponse Message Class Diagram according to an embodiment of the present invention;

FIG. 9 shows hierarchy of idsm Database Tables according to an embodiment of the present invention;

FIG. 10 shows the logger Database Tables according to an embodiment of the present invention;

FIG. 11 shows the Validate Request Message Happy Path according to an embodiment of the present invention;

FIG. 12 shows the Validate Message Components according to an embodiment of the present invention;

FIG. 13 shows the Process Request Happy Path according to an embodiment of the present invention;

FIG. 14 shows the IDSMRequest Message Schema Graph according to an embodiment of the present invention;

FIG. 15 is an example of an IDSMRequest Message according to an embodiment of the present invention;

FIG. 16 is an example of a LoginV1 Service Schema according to an embodiment of the present invention;

FIGS. 17a-c show an example of an IDSMRequest Message Schema according to an embodiment of the present invention;

FIG. 18 shows the IDSMResponse Message Schema Graph according to an embodiment of the present invention;

FIGS. 19a-c show an example of an IDSMResponse Message Schema according to an embodiment of the present invention;

FIG. 20 is a V22 Differencing POJO Class Diagram according to a specific example of the present invention;

FIG. 21 is a flow chart for the sequence of steps in V22 Differencing according to a specific example of the present invention;

FIG. 22 shows an example of a Jimis Request Payload Schema according to a specific example of the present invention; and

FIG. 23 shows an example of a Jimis Response Payload Schema according to a specific example of the present invention.

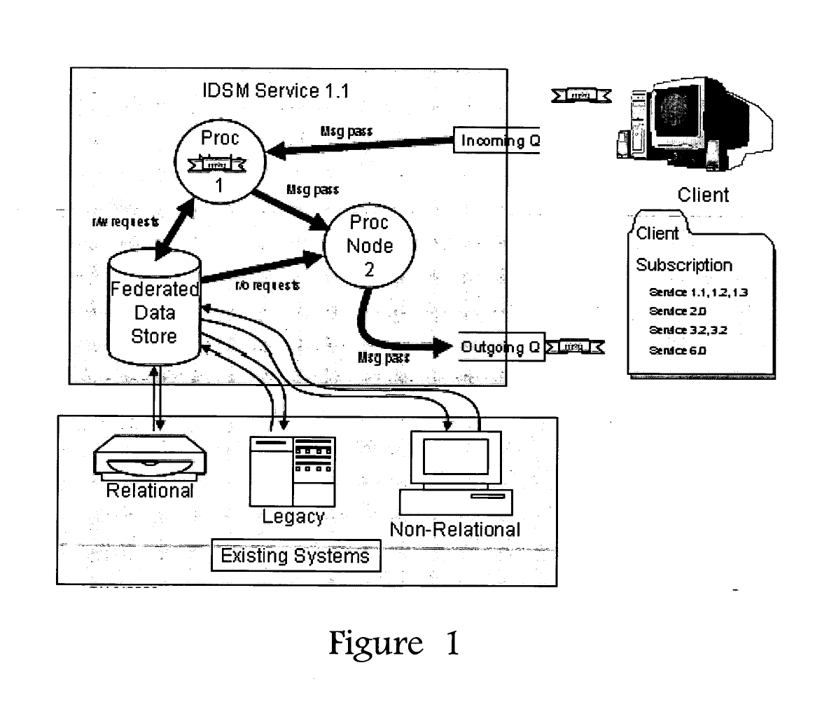

### DETAILED DESCRIPTION OF PREFERRED EMBODIMENTS

The invention summarized above and defined by the enumerated claims may be understood by referring to the following description, which should be read in conjunction with the accompanying drawings. This description of an embodiment, set out below to enable one to build and use an implementation of the invention, is not intended to limit the enumerated claims, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

The following is a list of terms and definitions used in this description.
AOP—Aspect Oriented Programming. The programming paradigm that attempts to aid programmers in the separation of concerns, or the breaking down of a program into distinct parts that overlap in functionality as little as possible. In particular, AOP focuses on the modularization and encapsulation of crosscutting concerns. Logging offers the prototypical example of a crosscutting concern, because a logging strategy necessarily affects every single logged part of the system. Logging thereby crosscuts all logged classes, methods, and procedures.
Certificate—In cryptography, a public key certificate (or identity certificate) is a certificate which uses a digital signature to bind together a public key with an identity—information such as the name of a person or an organization, their address, and so forth. The certificate can be used to verify that a public key belongs to an individual or organization.
DAO—Data Access Object. A component that provides a common interface between the application and one or more data storage devices.
DMZ—Demilitarized Zone. In network topology, the DMZ represents a region of the network that contains externally accessible services. This topology includes a second, more secure region that is behind a second firewall within the DMZ.
ERAC—Electronic Rapid Action Change.
ERD—Entity-Relationship Diagram. A diagram that pictorially represents entities, the relationships between them and the attributes used to describe them.
Firewall—Gateway that limits access between networks in accordance with local security policy.
HTTP—Hyper Text Transfer Protocol. A protocol (utilizing TCP) to transfer hypertext requests and information between servers and browsers.
HTTPS—HTTP Over SSL. Protocol enabling the secured transmission of Web pages.
IETM—Interactive Electronic Technical Manual.
Pattern—(a.k.a. Design Pattern) Design patterns provide solutions to common/recurring problems encountered in object-oriented programming.
POJO—Plain Old Java Object. In general, these are Java classes that do not implement any special interfaces (e.g., those defined by the EJB 2.0 framework).
REST—Representational State Transfer. Describes any simple web-based interface that uses XML and HTTP without the extra abstractions of MEP-based approaches like the web services SOAP protocol.
RMI—Remote Method Invocation. A Java application programming interface for performing remote procedure calls.
SOAP—Protocol for exchanging XML-based messages over a computer network, normally using HTTP. SOAP forms the foundation layer of the web services stack, providing a basic messaging framework that more abstract layers can build on.
SSL—Secure Sockets Layer. A protocol for securing data communications on the Internet, providing encryption and authentication of transactions.
Web Service—A software system designed to support interoperable machine-to-machine interaction over a network. It has an interface that is described in a machine-processable format such as WSDL. Other systems interact with the Web service in a manner prescribed by its interface using messages, which may be enclosed in a SOAP envelope, or follow a REST approach. These messages are typically conveyed using HTTP, and normally comprise XML in conjunction with other Web-related standards.
WSDL—Web Services Description Language. An XML-based service description on how to communicate using a web service; namely, the protocol bindings and message formats required to interact with the web services listed in its directory. The supported operations and messages are described abstractly, and then bound to a concrete network protocol and message format.
XML—Extensible Markup Language. A W3C-recommended general-purpose markup language for creating special-purpose markup languages, capable of describing many different kinds of data. Its primary purpose is to facilitate the sharing of data across different systems, particularly systems connected via the Internet.
   Well-formed. A well-formed document conforms to all of XML's syntax rules. For example, if a non-empty element has an opening tag with no closing tag, it is not well-formed. A document that is not well-formed is not considered to be XML; a parser is required to refuse to process it.
   Valid. A valid document has data that conforms to a particular set of user-defined content rules, or XML schemas, that describe correct data values and locations. For example, if an element in a document is required to contain text that can be interpreted as being an integer numeric value, and it instead has the text “hello”, is empty, or has other elements in its content, then the document is not valid.

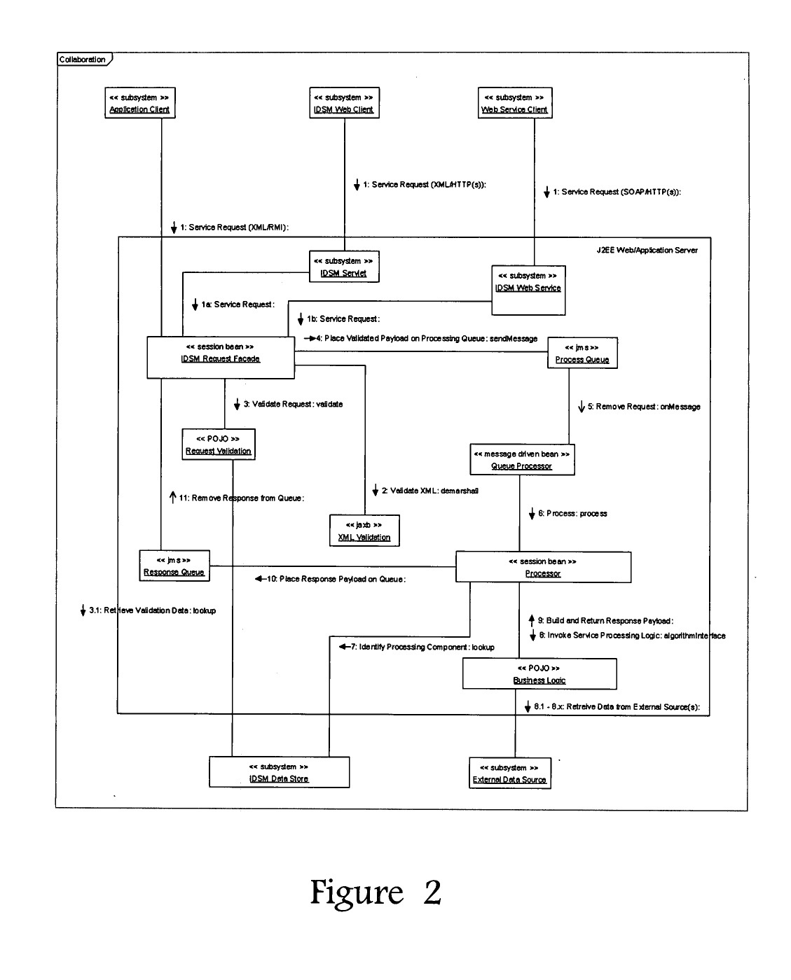

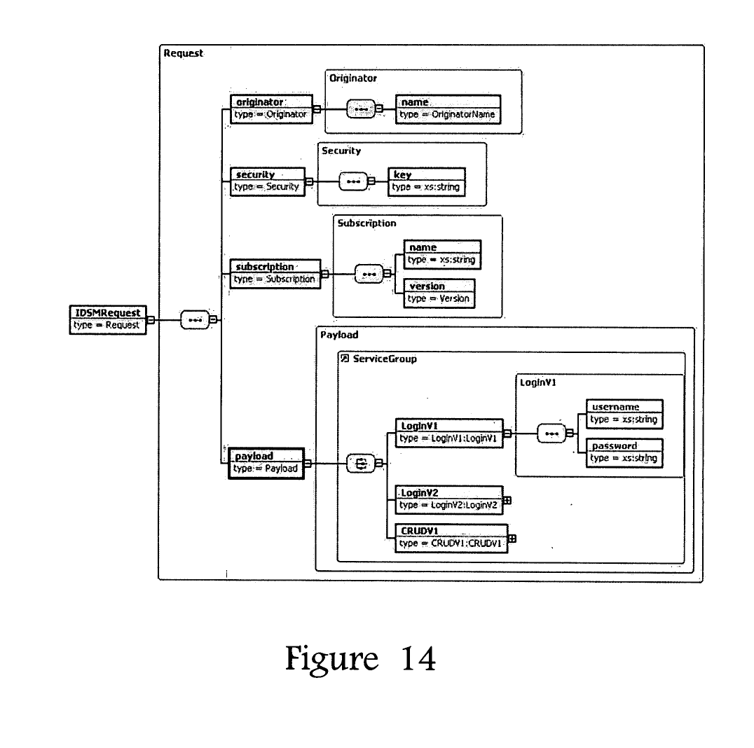

Referring to the drawings, FIG. 2 provides a collaboration diagram for an Inter Domain Services Manager (IDSM) processor framework. Referring to FIG. 2, the IDSM processor framework receives service-processing requests from standalone applications, web applications, and web service applications. These subsystems utilize an XML representation (see FIG. 14) of the service request to communicate with the IDSM processor framework. The message flow through the various subsystems and components of the IDSM is described below:
1. Service Request. These messages are forwarded to the IDSM Request Façade session bean.
2. Validate XML. The IDSM Request Façade session bean utilizes components of the JAXB specification to validate the received XML and demarshall same into a collection of POJOs representing the various types and fields of the received message.
3. Validate Request. The IDSM Request Façade session bean utilizes IDSM business validation logic to validate request content. This step involves:
   a. 3.1 Retrieve Validation Data. User, service, and subscription data are retrieved from the IDSM data stored and utilized for validation described in the subsequent steps of this process.
   b. Ensure the payload service matches the ServiceName and ServiceVersion attributes.
   c. Ensure a subscription id exists for the passed subscription name and version.
   d. Ensure that the passed service name/version is associated with the subscription.
   e. Ensure the user is associated with the subscription/version.
   f. Ensure the user has permissions to invoke the service/version.

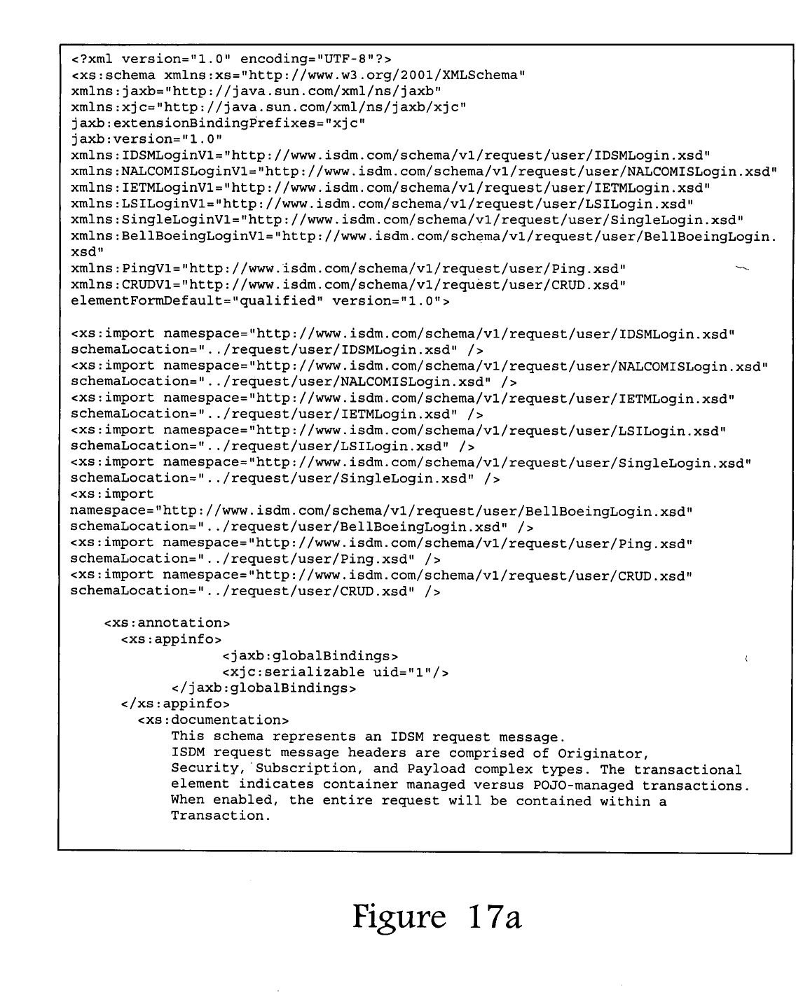

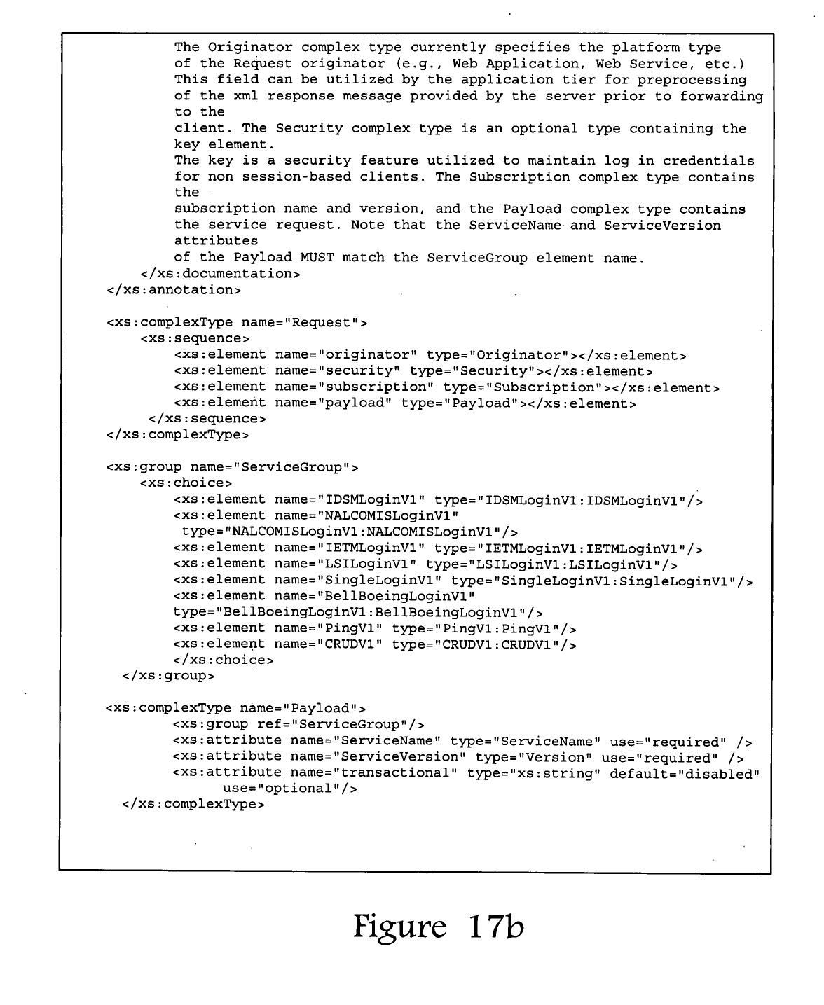

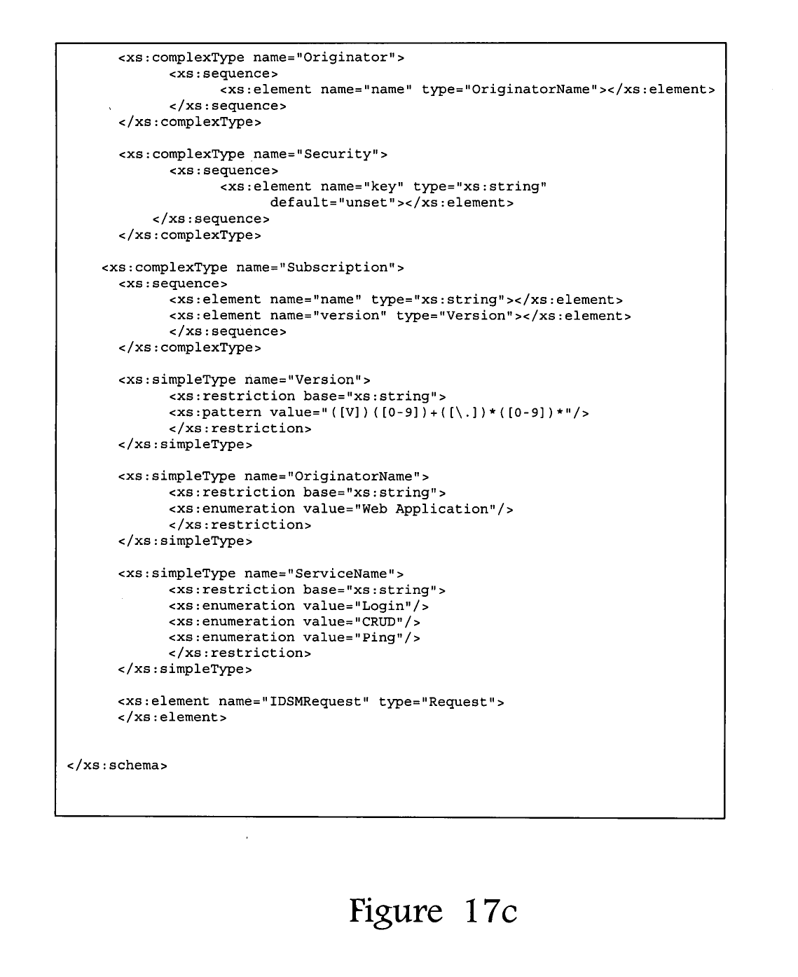

See FIGS. 17a-c for an example of an IDSMRequest Message Schema for identification of the message content.
4. Place Validated Payload on Processing Queue. Once the received request has been validated, the IDSM Request Façade session bean will extract the payload from the message and place the payload on the Process Queue.
5. Remove Request. The Queue Processor message driven bean removes the payload object from the queue.
6. Process. The QueueProcessor bean forwards the payload object to the Processor session bean.
7. Identify Processing Component. The Processor session bean identifies and loads the appropriate processing logic for the payload.
8. Invoke Service Processing Logic. The Processor bean invokes the business processing logic.
   8.1-8.x Retrieve Data from External Source(s). The processing logic interacts with various external legacy systems (and/or the IDSM data store) to collect the information associated with the service request. (Note that this interaction may involve JCA and other components not shown in the diagram.)
9. Build and Return Response Payload. The Business logic builds an appropriate payload response and returns same to the Processor bean.
10. Place Response Payload on Queue. The Processor bean places the response payload on the Response Queue.
11. Remove Response from Queue. The IDSM Request Façade bean removes the response payload from the queue, packages it within an IDSM Response xml message, and returns the response message to the client.

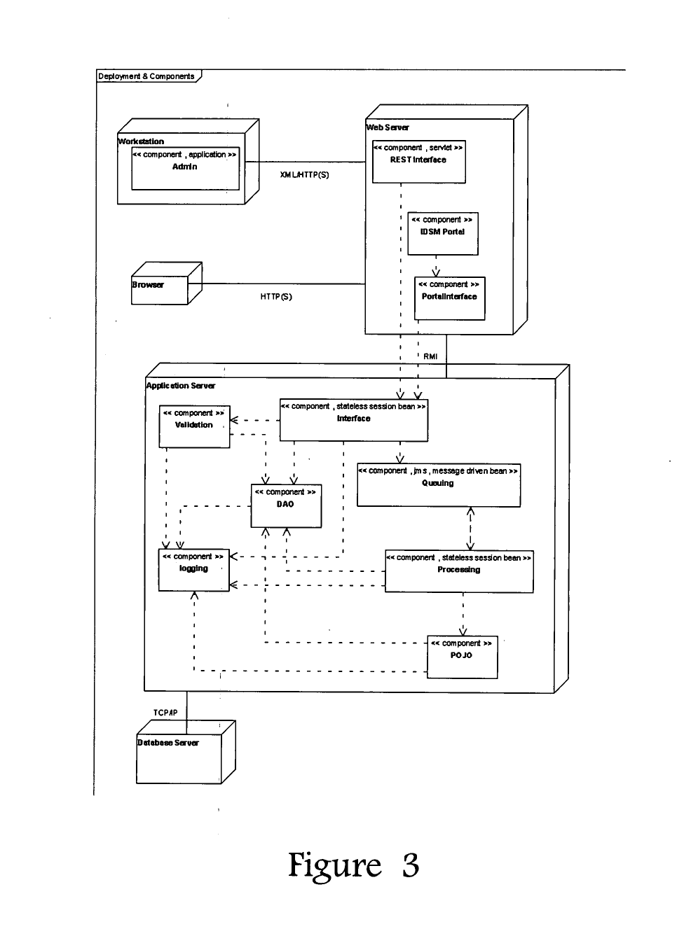

The deployment diagram for the IDSM framework is shown in FIG. 3. From the diagram, the IDSM Admin application; which is utilized for management of user accounts including logins, roles, services, and subscriptions; is deployed on a client workstation or PC. The Admin application communicates with the REST servlet via XML over HTTP(S), which, in turn, accesses the framework through the Interface component—a stateless session bean.

Clients utilize their browser to access the main IDSM application deployed within a Web Server as a web portal application. The portal component utilizes the PortalInterface component for navigation management and access to the IDSM processor framework. (Note that when the Web and Application servers are codeployed, local rather than remote interfaces will be utilized. That is, the indicated RMI interface may or may not be required.)

The remaining components within the application server provide the IDSM framework functionality introduced in the Collaboration Diagram section and described in greater detail below.

Class Diagrams

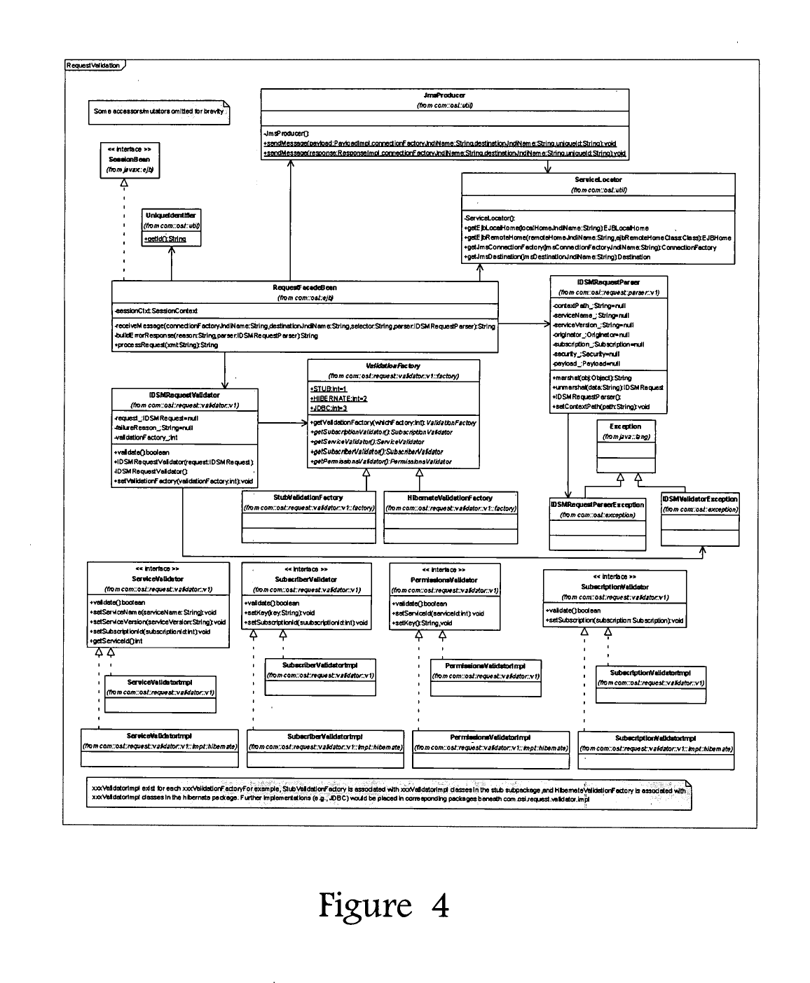

FIGS. 4-8 illustrate the class diagrams and descriptions for the various components of the IDSM framework.

FIG. 4 contains the class diagram for the request validation component of the framework.

RequestFacadeBean

The processRequest( . . . ) method of this stateless session bean provides the entry point into the IDSM Processor. This method accepts the IDSMRequest XML message and utilizes the IDSMRequestParser to validate the XML against the IDSMRequest schema and demarshall the message into the associated object representation. The IDSMRequestValidator is utilized to validate the Security, Subscription, and Service fields of the received message. The JmsProducer class is utilized by the RequestFacadeBean to place the received message's Payload onto the request queue with a unique identifier generated by the UniqueIdentifier class. Finally, the RequestFacadeBean utilizes the ServiceLocator class to obtain a JMS Destination associated with the response queue.

UniqueIdentifier

Utility class that provides a system-wide, unique String identifier.

JmsProducer

Helper class utilized for placing JMS messages on the queue.

ServiceLocator

Helper class that encapsulates JNDI lookups to ease access to JNDI-based resources such as EJBs, DataSources, and JMS Destinations.

IDSMRequestParser

This class encapsulates interaction with JAXB utilities for validation of XML against its associated schema and demarshalling of XML data into its associated object representation. This class also supports marshalling of the Response message object hierarchy into its associated XML representation.

IDSMRequestValidator

This class is responsible for validating the contents of the Security, Subscription, and Service fields of the IDSMRequest message. The class utilizes the ValidationFactory for creation and access to the appropriate IDSM data store to retrieve validation credentials and content.

ValidationFactory

Participant in the Abstract Factory pattern. Abstract class that declares interface for creation of concrete data store accessors.

StubValidationFactory

Participant in the Abstract Factory pattern. Concrete factory implementing creation of stubbed accesor classes.

HibernateValidationFactory

Participant in the Abstract Factory pattern. Concrete factory implementing creation of Hibernate-based accesor classes.

xxxValidator

Participant in the Abstract Factory pattern. Define interfaces for accessing Service, Subscriber, Permissions, and Subscription validation data.

xxxValidatorImpl

Participant in the Abstract Factory pattern. Implement the xxxValidator interfaces.

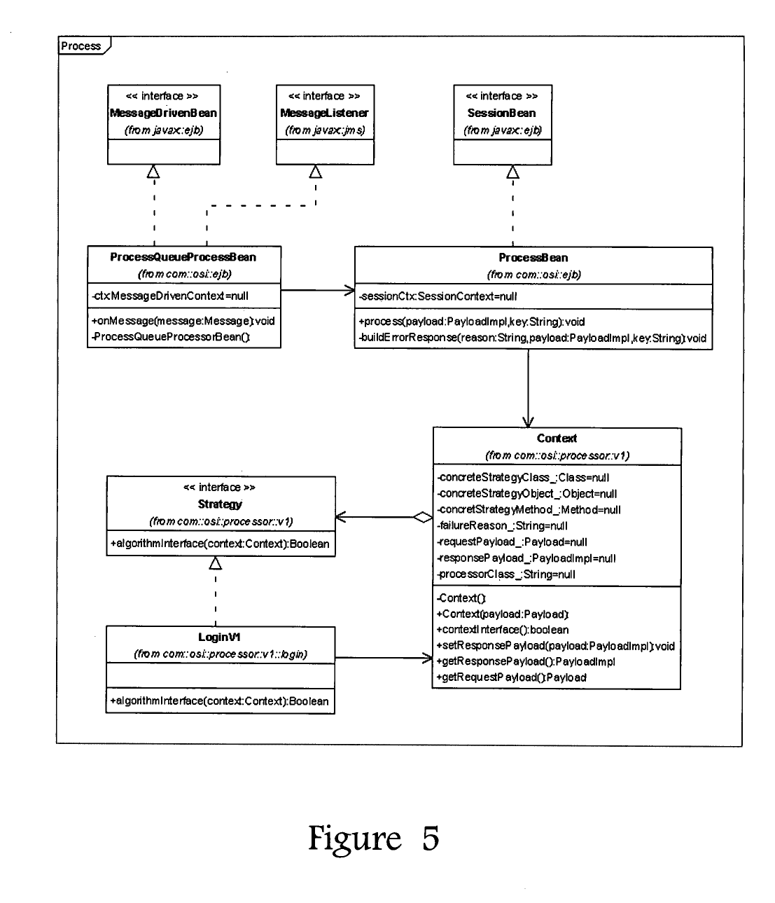

FIG. 5 contains the class diagram for the process component of the framework.

ProcessQueueProcessorBean

This message driven bean removes Payload objects from the Request queue and forwards it to the ProcessBean.

ProcessBean

The process( . . . ) method of this stateless session bean interacts with the Context class to provide service-specific business logic processing.

Context

Participant in the Strategy pattern. Utilizes the ServiceName and ServiceVersion attributes of the Payload object to load the appropriate business logic implementation from the IDSM data store.

Strategy

Participant in the Strategy pattern. Defines the interface for access to all business logic processing implementations.

LoginV1

A sample concrete strategy representing business logic for the ServiceName=Login ServiceVersion=V1 service.

The Strategy pattern enables new service implementations to be introduced without affecting the processor framework. By decoupling the framework from the services it supports, developers are able to independently develop and test service implementations; the impact of introducing new services on existing services and the framework is minimized; time-to-delivery for new services is reduced; and maintenance and regression testing efforts are minimized.

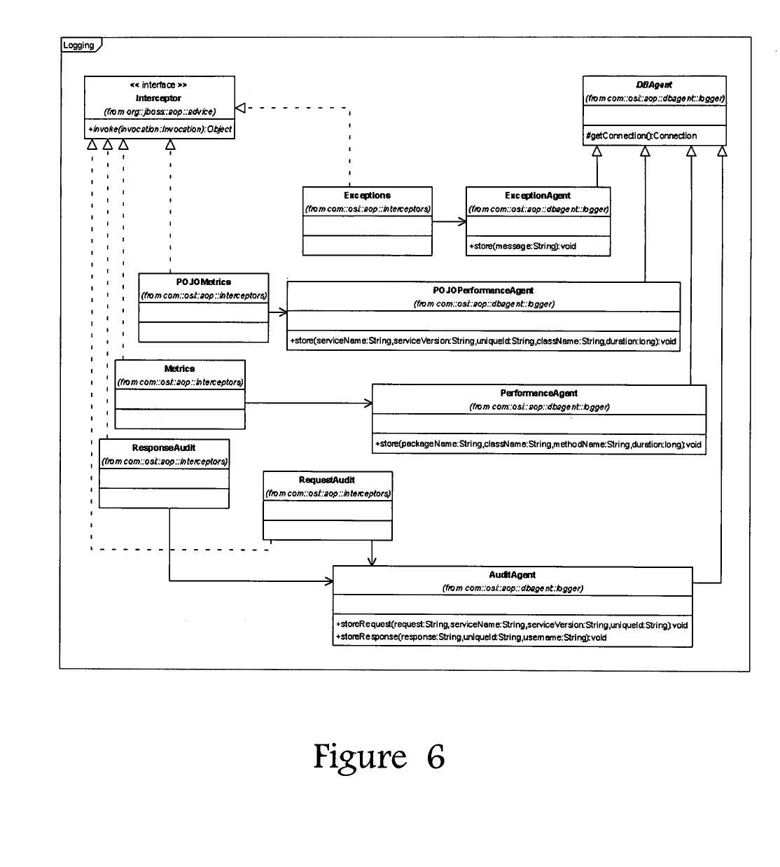

FIG. 6 contains the class diagram for the logging component of the framework.

Logging

The logging component utilizes AOP to facilitate introduction of logging into the various framework classes. AOP was chosen to eliminate the typical code bloat associated with traditional, inline logging solutions. The AOP logging component utilizes DB-resident logging tables. Database logging was chosen over flat-file logs for several reasons:
1. Using the MySQL, Mylsam storage engine is extremely efficient for INSERTS.
2. DB-resident logging provides a great deal of flexibility with respect to how data is viewed, supporting a myriad of query options including maximum and minimum execution times, average execution times, number of requests per hour, number of requests of a particular type, and number of failures per hour.
3. Logging files are cumbersome—difficult to read and maintain.

The ERD for the logging database can be found in the Database section below.

The Exceptions, POJOMetrics, Metrics, ResponseAudit, and RequestAudit classes implement the Interceptor interface. Each class extracts the information to be logged from the invoking object and utilizes its associated DBAgent specialization to write said information to the database. The DBAgent specializations serve as DAOs for the corresponding tables in the logger database.

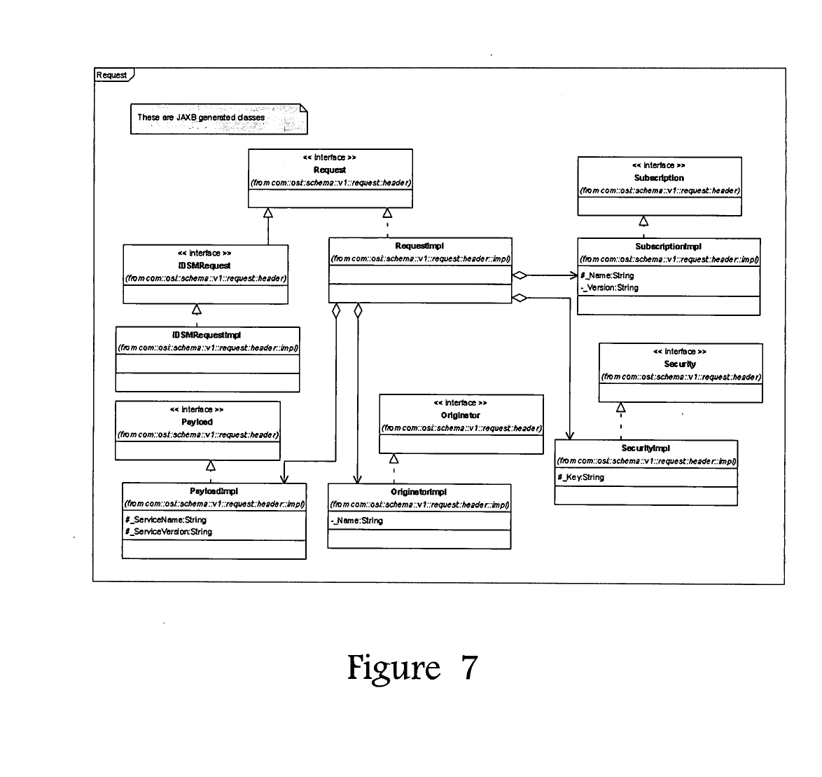

FIG. 7 contains the class diagram associated with the IDSMRequest message. These classes are generated by JAXB from the associated schema definition.

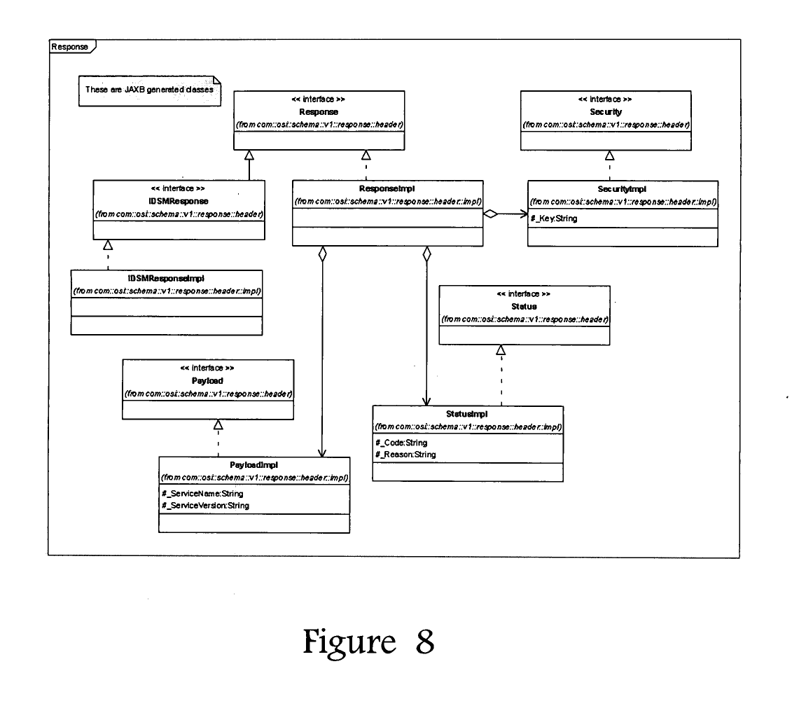

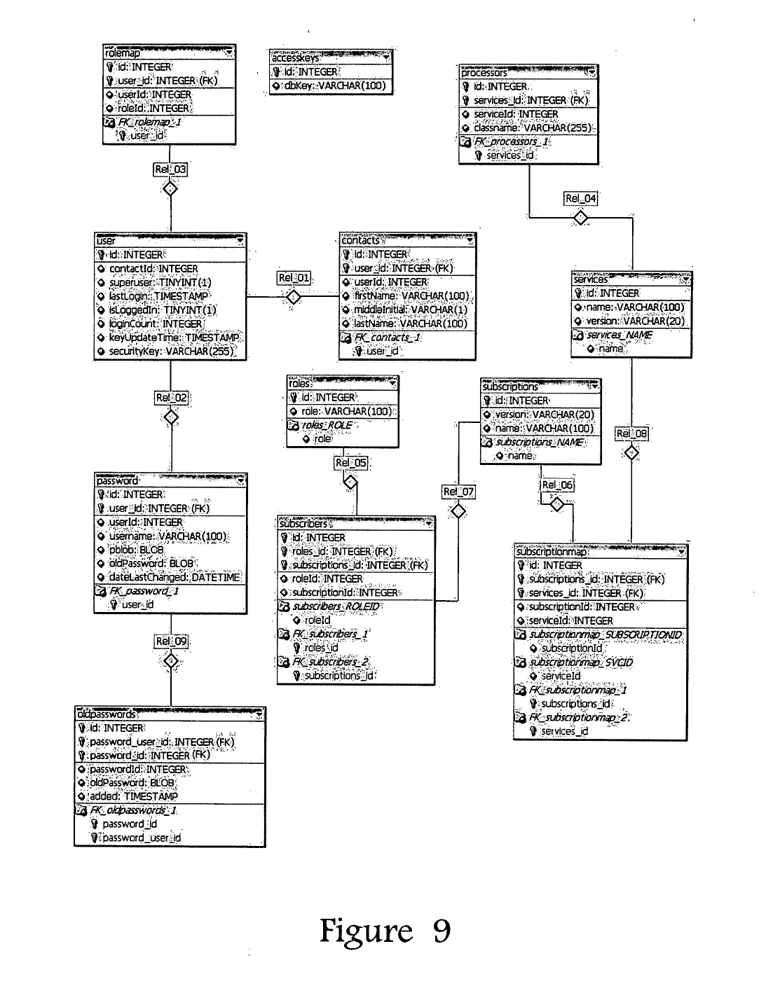

FIG. 8 contains the class diagram associated with the IDSMResponse message. These classes are generated by JAXB from the associated schema definition.

Database

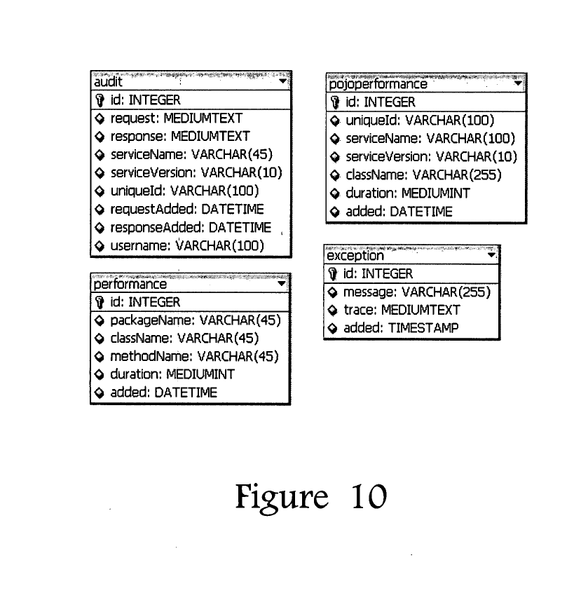

Referring to FIGS. 9 and 10, the following section describes the databases and associated tables utilized by the framework.

The ERD for the idsm database is depicted in FIG. 9, wherein the user, password, contacts, and oldpasswords tables collectively contain IDSM user information. The user table maps a given user to his associated password, contact data, and role assignments via the id key. Given that the rolemap, contacts, and password data is dependent upon a given user, each has a foreign key assignment to the user table id field ensuring that records are not deleted from the user table without first deleting the associated record(s) from the aforementioned, dependent tables. The oldpasswords table retains historical password data for a given user. Specifically, the previous five (tunable) passwords are retained. The system uses data in the oldpasswords table to ensure that a password is not changed back to an old password prior to the old password “aging” through the oldpasswords table. The oldpasswords table has a foreign key assignment to the password table's id field to ensure password records are not deleted without first deleting the associated record(s) in the oldpaswwords table.

The accesskeys table stores encrypted keys utilized by the system. Currently, this table holds only the key for encrypting and decrypting data in the database. The key itself is stored in an encrypted form.

The services and processors tables map IDSM services to their associated fully qualified POJO processor class names (i.e., the class that implements the associated service). The processors table maintains a foreign key association to the services class as processors cannot exist outside the context of the service they implement.

The subscriptionmap table maps a given subscription—defined in the subscriptions table—to all of its associated services in the services table. Similarly, the subscribers table maps roles—defined in the roles table—to one or more subscriptions in the subscriptions table. Given that the subscribers table is dependent upon both the roles and subscriptions tables, it maintains foreign key associations with both. Similarly, the subscriptionmap table is dependent upon both the subscriptions and services table; therefore, foreign key associations with these tables are maintained.

The logging component utilizes four logging tables: audit, performance, pojoperformance, and exception. The ERD for the logger database is depicted in FIG. 10.

The audit table contains each XML request message received by the framework (i.e., IDSMRequest) and its associated XML response message generated by the framework (i.e., IDSMResponse). Associated with each (request, response) pair is a timestamp indicating when the request was received and a timestamp indicating when the response was transmitted back to the client. Each record also contains the username associated with the IDSM user who initiated the request and the service name and service version associated with said request. Finally, a system-generated unique identifier is included in the record. (The unique identifier is created and utilized by the IDSM queuing mechanism to coordinate response messages with their associated request. That is, creation of the identifier is not associated with IDSM logging.) Inclusion of the identifier facilitates mapping the audit data to the POJO performance data; thereby, providing end-to-end processing traces. Since the IDSM is service-centric, all auditing requirements are captured in the audit table.

The performance table holds performance statistics (i.e., duration) for framework methods (tunable). The records in this table include the package name, class name, method name, the duration of the method, and a timestamp indicating when the statistic was logged. The primary intent of this table is to assist in identification of performance bottlenecks. Consequently, logging to this table will be limited in a production environment.

The pojoperformance table holds performance information for the POJO implementations. The capture of these statistics is transparent to the POJO developer through introduction of an appropriate pointcut at the com.osi.processor.v1.Context.contextInterface( ) boundary. The records in the pojoperformance table include the service name, service version, fully qualified path name of the POJO which implements said service, and the duration of the POJO service implementation. The pojoperformance data is associated with the audit data via the aforementioned unique identifier.

The exceptions table captures all exceptions associated with abnormal system behavior. The records in this table include the exception message and corresponding stack trace. These records also include a timestamp corresponding to the time at which the exception was generated. (Note that the framework utilizes several exception instances (e.g., ValidationException, ParserException, etc.) to capture message processing exceptions which do not represent abnormal system behavior. These exceptions are not logged in the exceptions table.

Security

The IDSM framework utilizes a combination of login credentials, role assignments, and security key maintenance within its software security model.

Login Credentials

All users of the EDSM framework are required to possess a user id and password. The system stores password data in encrypted format within the database, requires that passwords are periodically changed according to a tunable expiration period, and ensures that new passwords are not chosen from a system maintained list (the size of the list is a tunable parameter) of previous passwords.

Role Assignments

Every user of the IDSM is assigned one or more security roles. These roles identify to which subscription(s) a given user has access. System administrators define security roles, map IDSM service offerings to subscriptions, and subscriptions to roles. Consequently, the framework can restrict access to a given service (and version) based upon a user's assigned role(s).

Security Key

All IDSM request messages are required to include a security key. The security key is randomly generated by the system and transmitted to the user in encrypted format within the header of every IDSM response message. Clients are required to return the last received key within the header of their request message. The system compares the received security key to that stored within its database and rejects any message which does not contain a security key, contains an invalid key, or contains an expired security key (security keys expire after a tunable time period, and a new key is generated upon receipt of every IDSMRequest). Anytime a security key validation fails, the associated user is logged out of the system and must resubmit login credentials before any additional requests will be processed by the system. The system maintains all requests and responses in the logger audit table; thereby, facilitating identification of security exceptions.

Additional Measures

Software

Dependant upon the needs of a given IDSM client, additional security measures can be provided. These include full encryption using HTTPS and the use of certificates to facilitate server and client proof of identity requirements.

Network Topology

The physical layout of the network upon which the IDSM network is deployed can significantly influence its vulnerability. It is anticipated that the deployed hardware will utilize both an outer firewall and inner firewall with service exposure provided by proxy or web servers in the DMZ and database servers (and potentially application servers) behind the inner firewall. The specifics of this configuration are dependent upon deployment budget and client needs.

Sequence Diagrams

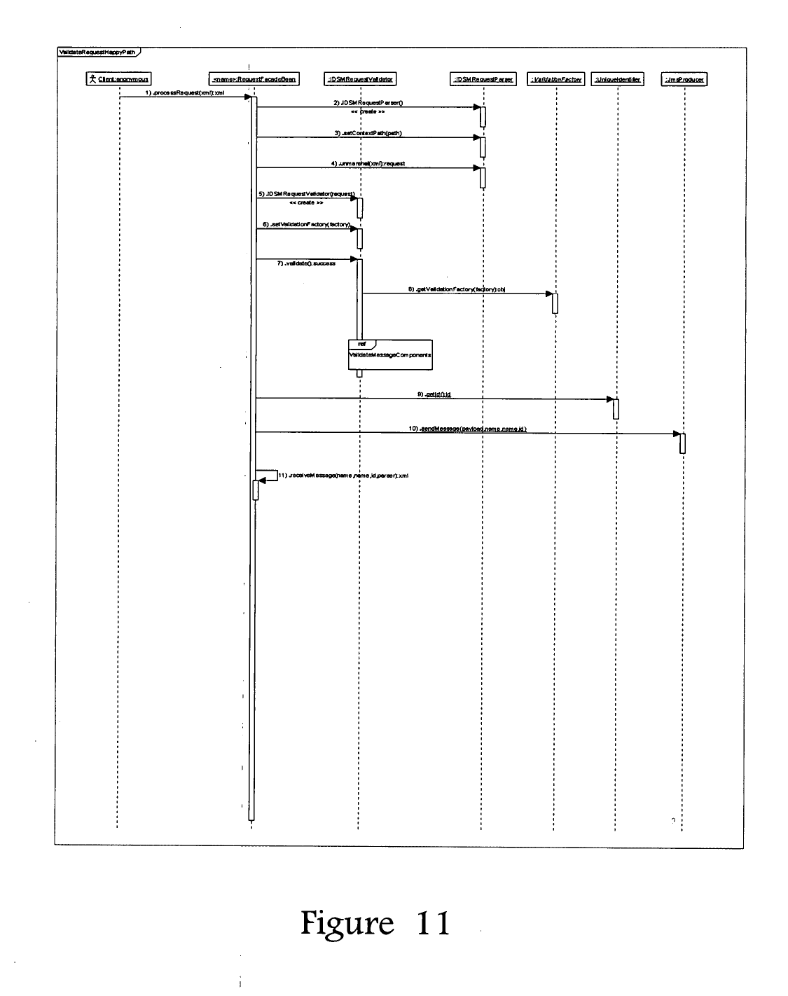

FIGS. 11-13 show sequence diagrams illustrating object interactions as messages flow through the IDSM framework.

Validate Request Happy Path

Referring to FIG. 11, the validate request happy path sequence diagram illustrates normal flow of execution for receipt and validation of an IDSMRequest message. The processing steps depicted in the diagram are discussed below:
1. An IDSM client (e.g., application, web service component, web application component) invokes the processRequest method of the RequestFa cadeBean, passing in the IDSMRequest message as a well-formed XML message.
2. The RequestFacadeBean instantiates an IDSMRequestParser.
3. The RequestFacadeBean invokes the parser's setContextPath method passing in the package in which the associated jaxb.properties file is located. (The jaxb.properties file is an artifact of the JAXB binding compiler (xjc). This compiler also generates the Java source files associated with the IDSMRequest (see FIG. 7) and IDSMResponse (see FIG. 8) message schemas.)

4. The RequestFacadeBean invokes the parser's unmarshal method passing in the received xml. The unmarshal method utilizes the JAXBContext class to create an Unmarshaller instance which is in turn utilized to unmarshal the xml String into an appropriate collection of Java objects. This process is illustrated in the following code fragment:

```
JAXBContext context = JAXBContext.newInstance(contextPath_);
//An Unmarshaller instance is created.
Unmarshaller unmarshaller = context.createUnmarshaller( );
StringBuffer xmlStrBuffer = new StringBuffer(data);
    IDSMRequest obj = (IDSMRequest)unmarshaller.unmarshal(new
        StreamSource(newStringReader(xmlStrBuffer.toString( ))));
serviceName_{—} = obj.getPayload( ).getServiceName( );
serviceVersion_{—} = obj.getPayload( ).getServiceVersion( );
    originator_{—} = obj.getOriginator( );
    subscription_{—} = obj.getSubscription( );
    security_{—} = obj.getSecurity( );
    payload_{—} = obj.getPayload( );
return obj;
```

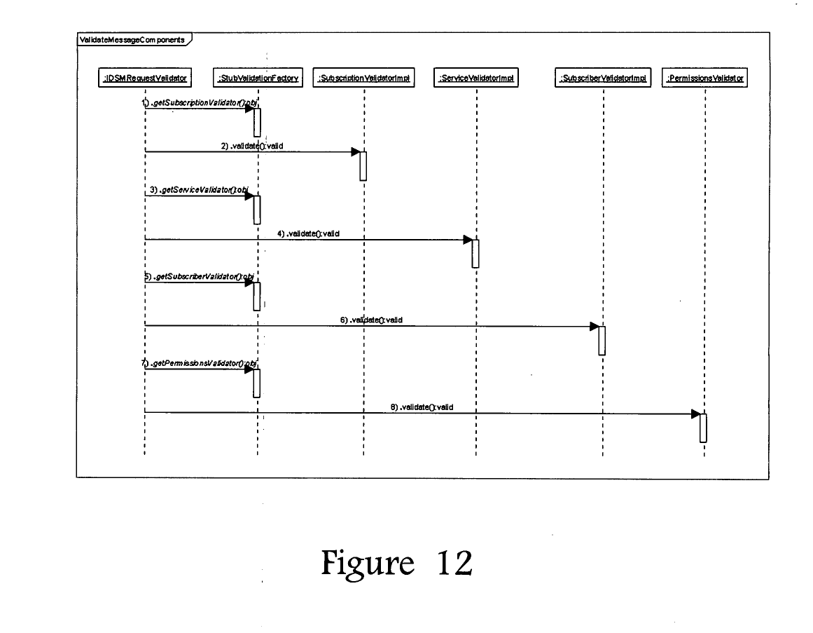

From the above, the various types of the IDSMRequest message are extracted and stored in associate attributes of the parser instance, and a reference to the IDSMRequest object is returned.
5. The RequestFacadeBean instantiates an ISDMRequestValidator passing into the constructor the IDSMRequest object returned by the IDSMRequestParser in Step 4.
6. The RequestFacadeBean invokes the IDSMRequestValidator's setValidationFactory method passing in the int constant representation of the appropriate factory (e.g., JDBC).
7. The RequestFacadeBean invokes the IDSMRequestVlidator's validate method. The validate ensures that ServiceName and ServiceVersion attributes of the Payload type match the ServiceGroup embedded in the Payload.
8. The IDSMRequestVaqlidator retrieves the ValidationFactory stored in Step 6. This validation factory is utilized to access/invoke, in turn, the validate method of the SubscritpionValidationImpl, ServiceValidationImpl, SubscriberValidationImpl, and PermissionsValidationImpl. (These combined steps are denoted by the ValidateMessageComponents reference activity—see FIG. 12).
9. The RequestFacadeBean utilizes the UniqueIdentifier's getid method to generate a unique identifier for the current message.
10. The RequestFacadeBean utilizes the JmsProducer's sendMessage method to place the Payload of the IDSMRequest message onto the Process queue.

11. The RequestFacadeBean invokes its receiveMessage method. This method will wait for an IDSMResponse message with an identifier matching that obtained in Step 9 to arrive on the Response queue. (The maximum wait time is a tunable parameter.) Upon receipt of a valid response, the message will be marshalled into its associated XML String and returned to the client. The steps involved in this process are illustrated in the following code fragment:

```
ConnectionFactory connectionFactory = null;
connectionFactory =
ServiceLocator.getJmsConnectionFactory(connectionFactoryJndiName);
connection = connectionFactory.createConnection( );
connection.start( );
session = connection.createSession(false,
Session.AUTO_ACKNOWLEDGE);
destination = ServiceLocator.getJmsDestination(destinationJndiName);
messageConsumer = session.createConsumer(destination,selector);
long startTime = System.currentTimeMillis( );
long waitTime = MAX_RESPONSE_WAIT_TIME;
Message rcvdMsg = messageConsumer.receive(waitTime);
if (rcvdMsg instanceof ObjectMessage) {
ObjectMessage objMessage = (ObjectMessage) rcvdMsg;
  Object obj = objMessage.getObject( );
if (obj instanceof
com.osi.schema.v1.response.header.impl.IDSMResponseImpl) {
      String result = null;
      com.osi.schema.v1.response.header.impl.IDSMResponseImpl
          response = (com.osi.schema.v1.response.header.impl.-
          IDSMResponseImpl) obj;
      parser.setContextPath(“com.osi.schema.v1.response.header”);
      String xml = parser.marshal(response);
      System.out.println(“RequestFacadeBean.receiveMessage( )
      response:\n”+xml);
      return xml;
}
```

Process Request Happy Path

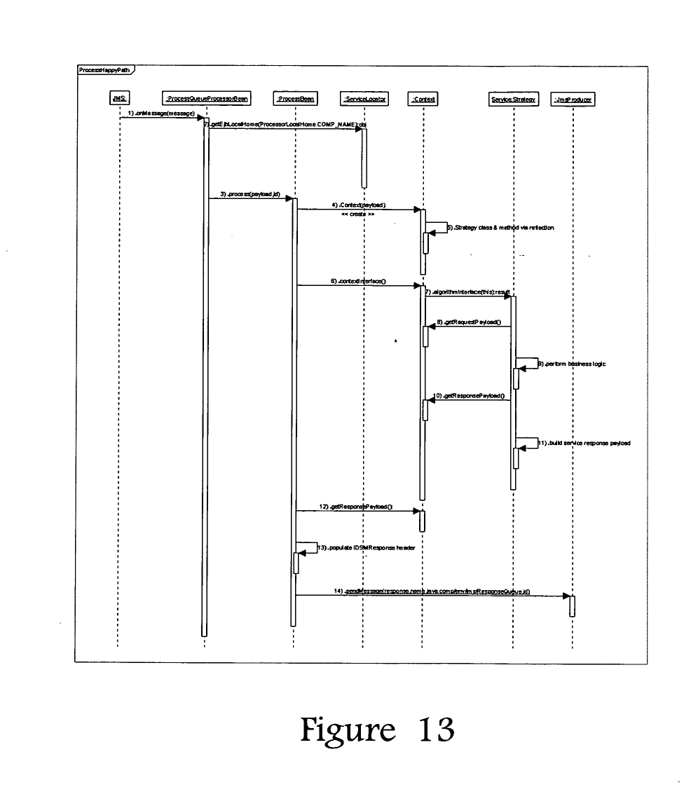

Referring to FIG. 13, the process request happy path sequence diagram illustrates normal flow of execution for processing of an IDSMRequest message. The processing steps depicted in the diagram are discussed below:
1. The on Message method of the ProcessQueueProcessorBean is invoked.
2. The ProcessQueueProcessorBean utilizes the ServiceLocator helper class to lookup the local interface for the ProcessBean.
3. The ProcessQueueProcessorBean invokes the process method on the ProcessBean passing in the Payload object and the unique message identifier created in Step 9 of the Validate Request Happy Path.
4. The ProcessBean instantiates a Context object passing in the Payload object to the constructor.

5. The Context object's constructor utilizes reflection to load the appropriate Class and Method objects, which implement the business logic corresponding to the ServiceName, and ServiceVersion attributes of the IDSMRequest Payload. This process is illustrated in the following code fragment:

//load the ConcreteStrategy class
Class[ ] parameterTypes = new Class[ ]
{com.osi.processor.v1.Context.class};
concreteStrategyClass_{—} = Class.forName(className);
concreteStrategyMethod_{—} =
concreteStrategyClass_.getMethod(Strategy.interfaceName,
parameterTypes);
concreteStrategyObject_{—} = concreteStrategyClass_.newInstance( );

6. The ProcessBean invokes the Context object's contextinterface method.

7. The Context.contextInterface( ) method invokes the Strategy implementation object's (that is, the object loaded via reflection in Step 5) algorithmInterface method passing in a reference to itself. (Note that in FIG. 5, the LoginV1 class is an example of a Strategy implementation object.) This process is illustrated in the following code fragment:

Object [ ] contextObject = new Object[ ]{this};
Object retObj = concreteStrategyMethod_.-
invoke(concreteStrategyObject_, contextObject);
result = ((Boolean)retObj).booleanValue( );

8. The Strategy implementation object retrieves the Request from the Context object.
9. The Strategy object performs its business processing logic. (This step is necessarily service dependent and will be documented in the associated Service documentation artifacts.)
10. The Strategy implementation object retrieves the Payload object from the Context.
11. The Strategy implementation object populates the Payload with the appropriate objects corresponding to an IDSMResponse schema for the given ServiceName and ServiceVersion.
12. The ProcessBean retrieves the Response from the Context object.
13. The ProcessBean populates the IDSMResponse message header objects (i.e., Status and Security).
   The ProcessBean utilizes the JmsProducer helper class to place the Response object on the ResponseQueue with its associated unique identifier. (see Step 11 of Validate Request Happy Path for subsequent processing of this message.)
   IDSMRequest Message Schema

FIGS. 14-17 are used to describe the schema for the IDSMRequest message. A graph of the IDSMRequest schema is provided in FIG. 14. Referring to FIG. 14, the IDSMRequest schema is comprised of a header containing originator, security, subscription, and payload data.

Originator

The Originator type includes a name field providing a string description of the client from which the request originated.

Security

The Security type includes a key field. The key is a framework-generated, encrypted string utilized to identify a validated session. The key will be returned by the framework in all response messages and must be supplied by the client in all requests (except login). The key is effectively a session identifier and provides a consistent validation mechanism across all client types (e.g., web, application, and web service.) Keys are valid for a system defined, tunable timeframe. Submission of an invalid or expired key will result in an error response message from the framework. A valid Login request message will be required to establish a new key.

Subscription

The Subscription type includes a name field and a version field. Both fields are mandatory and are validated by the framework to ensure that the requested service is associated with the supplied Subscription name and version.

Payload

Service-specific data is bundled under the Payload type. The Payload type includes mandatory attributes ServiceName and ServiceVersion identifying the requested service. The framework validates the ServiceName and ServiceVersion attributes to ensure said service is associated with the supplied subscription and the user has permissions to invoke the service.

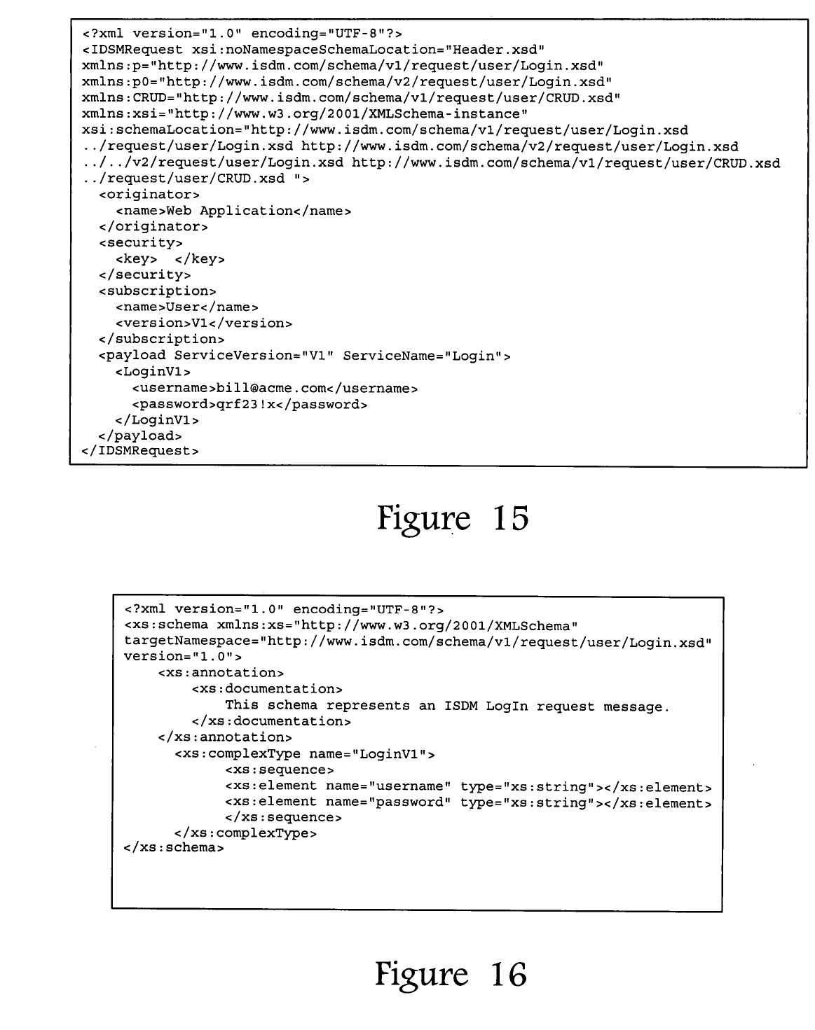

FIG. 15 illustrates a sample Login request message. A unique schema is defined for each ServiceName/ServiceVersion. As new services are introduced, the IDSMRequest schema can be updated to reflect addition of the new service to the ServiceGroup. For reference and completeness, the schema for the LoginV1 service described in this section is illustrated in FIG. 16.

From the schema shown in FIG. 16, the Login V1 complexType corresponds to the ServiceGroup reference in the IDSMRequest schema. This data will be bundled in the IDSMRequest message Payload.

A complete IDSMRequest Message schema definition can be found in FIGS. 17a-c.

IDSMResponse Message Schema

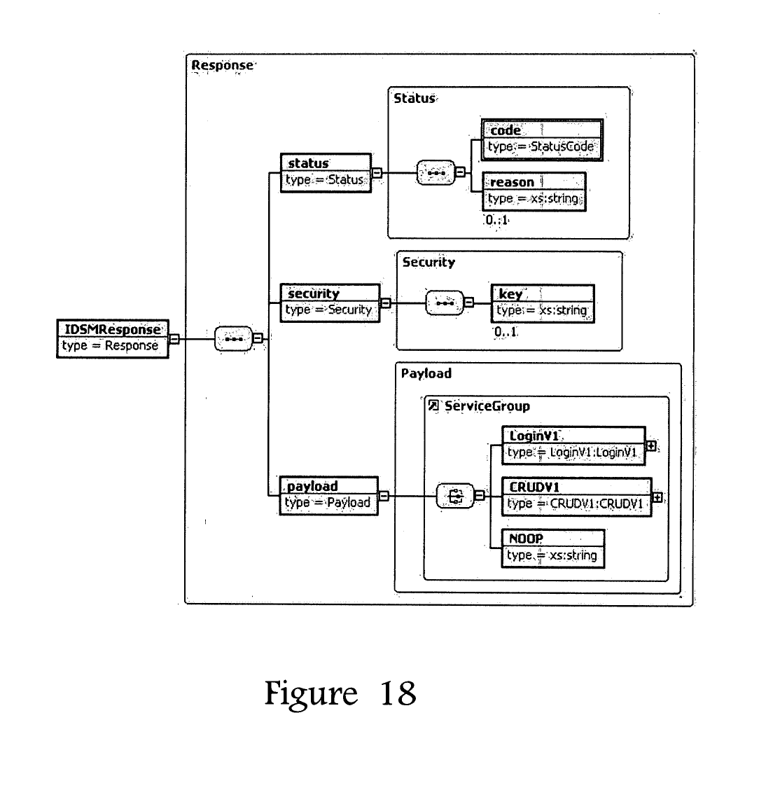

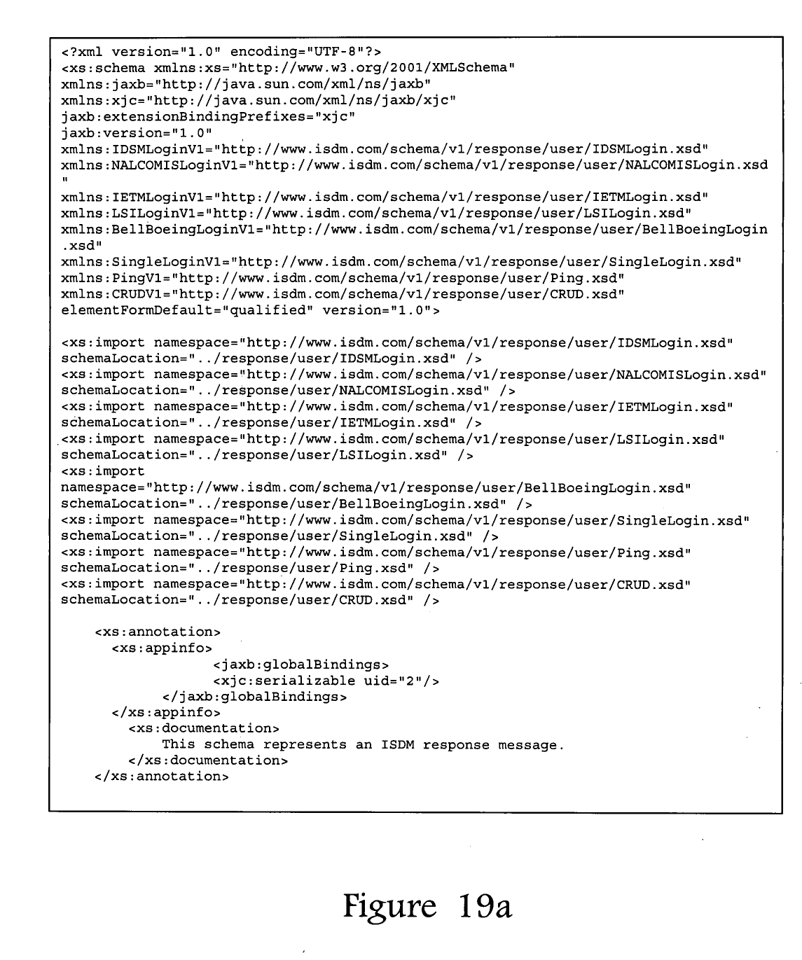

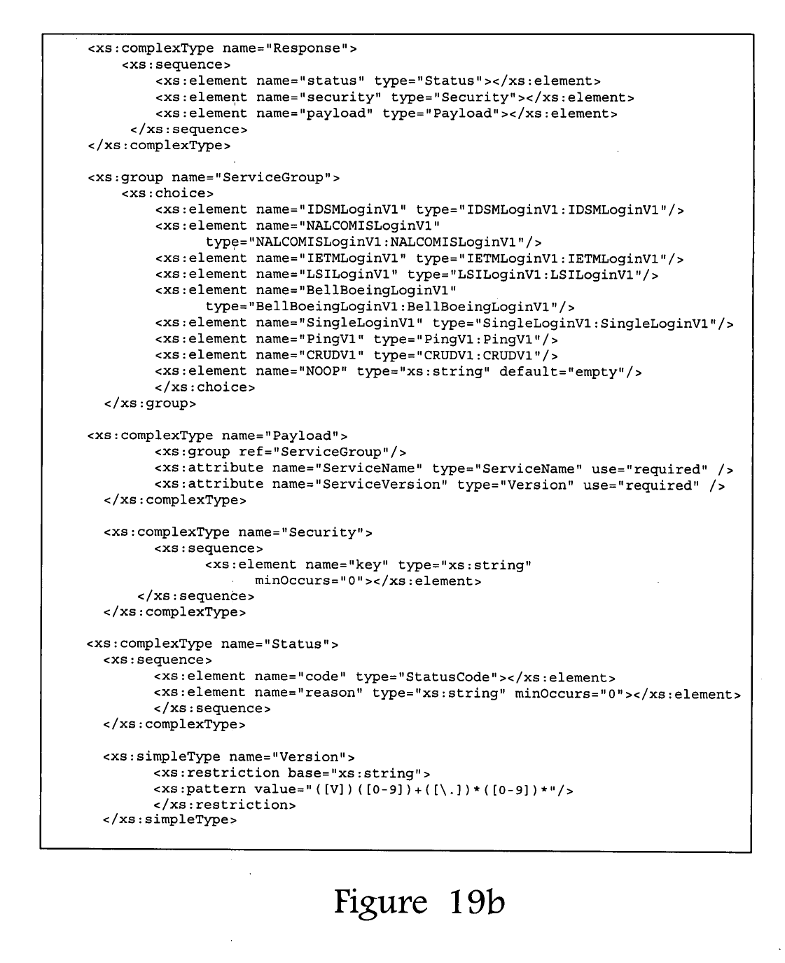

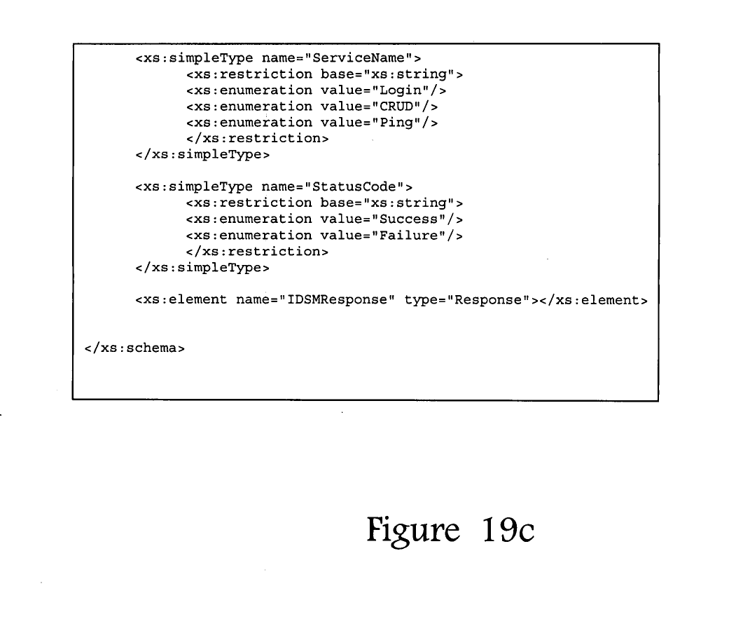

FIGS. 18 and 19 are used to describe the schema for the IDSMResponse message. A graph of the IDSMResponse schema is provided in FIG. 18. Referring to FIG. 18, the IDSMResponse schema is comprised of a header containing status, security, and payload data.

Status

The Status type includes a code field indicating either Success or Failure of the processing request. An optional reason field is included. This field may provide a textual description of the reason why the IDSMRequest failed.

Security

The Security type includes a key field. The key is a framework-generated, encrypted string utilized to identify a validated session. The key will be returned by the framework in all response messages and must be supplied by the client in all requests (except login). The key is effectively a session identifier and provides a consistent validation mechanism across all client types (e.g., web, application, and web service.) Keys are valid for a system defined, tunable timeframe. Submission of an invalid or expired key will result in an error response message from the framework. A valid Login request message will be required to establish a new key.

Payload

Service-specific response data is bundled under the Payload type. The Payload type includes mandatory attributes ServiceName and ServiceVersion identifying the requested service.

A complete IDSMResponse Message schema definition can be found in FIGS. 19a-c.

Now a specific embodiment of the present invention will be described with reference to the IDSM Request and Response message schema associated with extraction of the V22 Osprey maintenance procedures, providing appropriate UML diagrams and associated descriptions of the processing component, and identifying processes and procedures associated with configuring the IDSM framework to operate over given version(s) of the maintenance procedure data. This example of the V22 Maintenance Procedures Differencing (V22MPD) component provides an automated process whereby developers of training documentation for the V22 Osprey can quickly identify changes to the source maintenance procedures and incorporate the changes into their training materials.

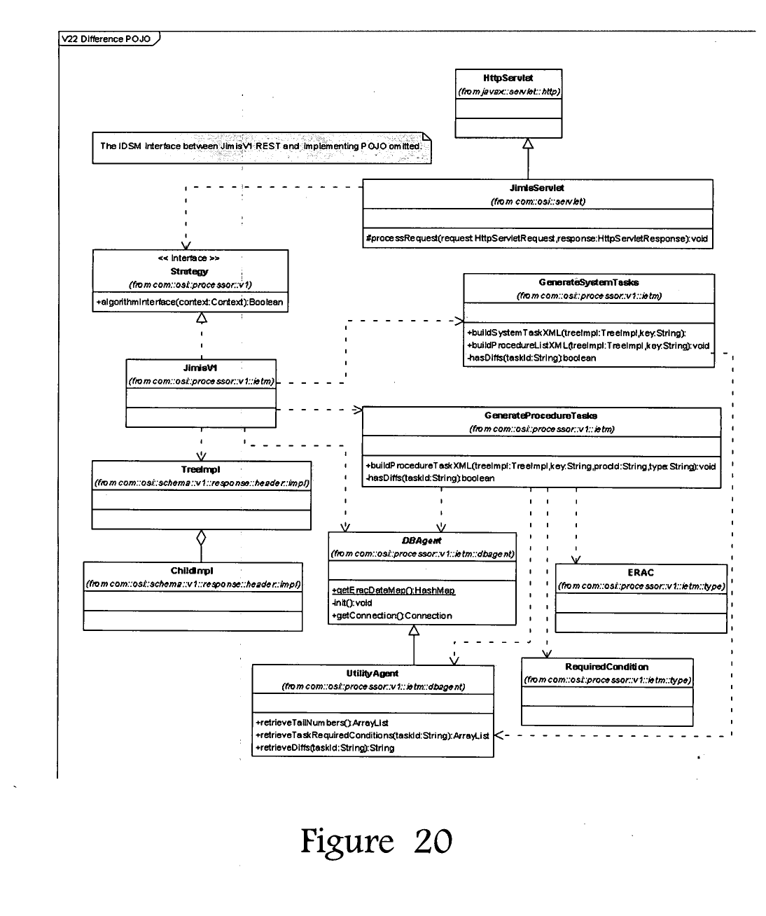

Referring to FIG. 20, a class diagram for the V22 Differencing POJO and support classes is depicted.

Strategy

This interface is associated with the IDSM Framework and is a participant in the Strategy pattern. It defines the interface for access to all business logic processing implementations. In particular, it is implemented by the JimisV1 class to facilitate invocation of it upon receipt of IDSMRequest messages containing a JimisV1 service name and service version.

JimisServlet

This is the client REST interface. This class is responsible for receiving client XML over HTTP requests, forwarding it to the IDSM, and returning the IDSMResponse message to the client. (Refer to the parent document, IDSM Software Architecture and Design, for a detailed description of the IDSM processing.)

JimisV1

This is the implementing POJO for the JimisV1 service. This class is responsible for interrogating the IDSMRequest message and invoking the appropriate methods of the GenerateSystemTasks, GenerateProcedureTasks, and UtilityAgent classes.

TreeImpl

This is a JAXB-generated class representing the Tree structure for IDSMResponse message payload.

ChildImpl

This is a JAXB-generated class representing a child node of the IDSMResponse message payload.

GenerateSystemTasks

This class builds the child nodes associated with the system task tree (method buildSystemTaskXML( . . . )) and the procedure list tree (method buildProcedureListXML( . . . )).

GenerateProcedureTasks

This class builds the child nodes associated with a given task from the procedure list. Specifically, the buildProcedureTaskXML( . . . ) method will build child nodes for the task's required conditions, associated ERACs, warnings, notes, and steps.

DBAgent

This abstract class provides database connection management and caching of the task-to-ERAC mapping HashMap object.

UtilityAgent

This class provides retrieval of all tail numbers in the Phoenix DB (method retrieveTailNumbers( )) and all required conditions for a given task (method retrieveTaskRequiredConditions( . . . )).

ERAC

This is a utility class that stores information about a specific ERAC.

Required Condition

This is a utility class that stores information about a given required condition.

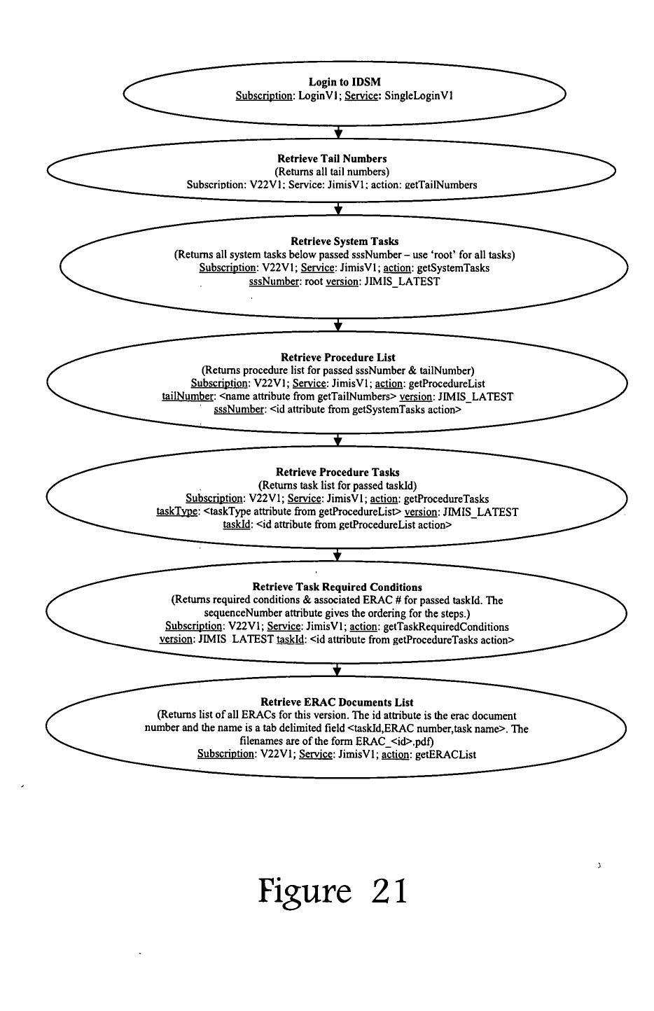

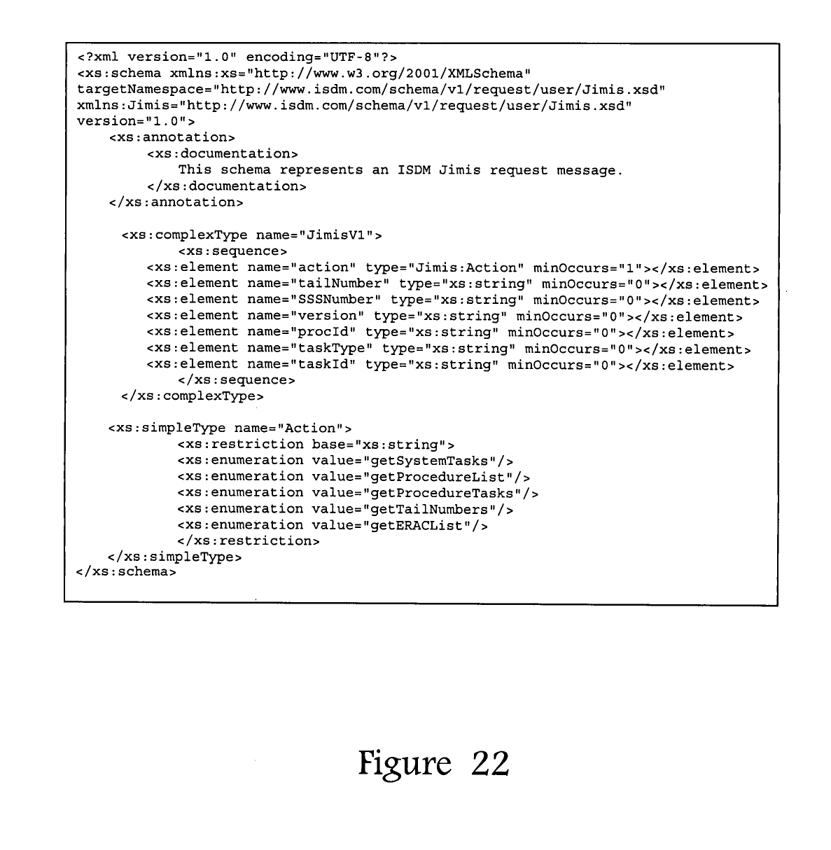

According to this specific embodiment, the V22MPD utilizes the IDSMRequest and IDSMResponse message Payload objects for submission of the JimisV1 service requests and receipt of the associated responses. FIG. 21 shows the Request messages that must be invoked and their order of invocation for the client application to build the differencing view. The schema for a Jimis Request payload is depicted in FIG. 22. A sample XML request for the Phoenix system tasks is depicted below.

```
<?xml version=“1.0” encoding=“UTF-8” standalone=“yes”?>
<IDSMRequest>
    <security>
        <key></key>
    </security>
    <subscription>
        <name>V22</name>
        <version>V1</version>
    </subscription>
    <payload ServiceName=“Jimis” ServiceVersion=“V1”
    originator=“V22”>
        <JimisV1>
            <action>getProcedureList</action>
            <tailNumber>020024</tailNumber>
            <SSSNumber>J-0020</SSSNumber>
              <version>JIMIS_LATEST</version>
        </JimisV1>
    </payload>
</IDSMRequest>
```

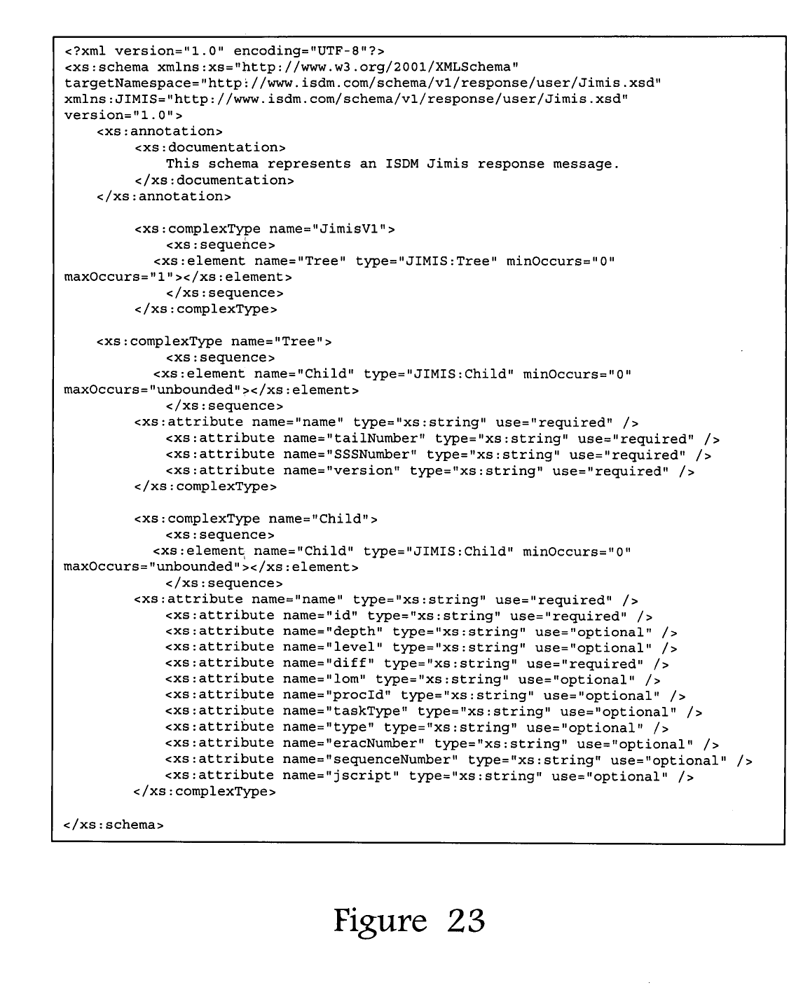

The schema for the Jimis Response payload is depicted in FIG. 23. A sample XML response for the Phoenix system tasks is depicted below.

```
<?xml version=“1.0” encoding=“UTF-8” standalone=“yes”?>
<IDSMResponse>
    <status>
        <code>Success</code>
    </status>
    <security>
        <key></key>
    </security>
    <payload ServiceName=“Jimis” ServiceVersion=“V1”>
        <JimisV1>
            <Tree SSSNumber=“J-0020” name=“Procedure List”
tailNumber=“020024” version=“JIMIS_LATEST”>
                <Child depth=“0” diff=“none”
id=“J-RECTIFICATION---1000042064” jscript=“getProcedureTasks”
lom=“OL” name=“AIRCRAFT SAFE FOR MAINTENANCE”
procId=“J-PROC---4804510430” taskType=“RECT”/>
                <Child depth=“0” diff=“none”
id=“J-RECTIFICATION---8105373927” jscript=“getProcedureTasks”
lom=“OL” name=“PERFORM FLIGHT
CONTROL SYSTEM PRE-FLIGHT TEST” procId=“J-PROC---
8105373922” taskType=“RECT”/>
            </Tree>
        </JimisV1>
    </payload>
</IDSMResponse>
```

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. In a distributed processing environment wherein each system within the distributed environment is independently managed a method for a user to access, retrieve, manipulate, and store said data across all said systems from a centralized application, comprising the steps of:
a. user logging into application;
b. application identifying subsystems to which said user has access permission;
c. application automatically logging into each of the identified subsystems;
d. application providing a consolidated view of data from all said subsystems; and
e. application providing for the manipulation and update of data from/to each subsystem both independently and collectively.

2. The method according to claim 1, wherein said step of logging into the application is done via a web browser.

3. The method according to claim 1, wherein said step of logging into the application is done via an application.

4. The method according to claim 1, wherein said step of logging into the application is done via a web service interface.

5. The method according to claim 1, wherein said step of identifying subsystems to which said user has access is configured by an application user with appropriate permissions.

6. The method according to claim 1, wherein the application simultaneously supports multiple users each of which may access the same or different subsystems.

7. The method according to claim 6, wherein the application incorporates a data store and associated interface logic that maps a given application user's login credentials to the subsystems to which said user has access.

8. The method according to claim 1, wherein said step of the application automatically logging into the subsystems is done by a collection of program modules comprising:
a. selection of module encapsulating interface(s), protocol(s), and permissions for logging into given subsystem;
b. mapping execution of said module to application credentials of a given user; and
c. execution of each of said modules when said user logs into application.

9. The method according to claim 8, wherein said step of mapping execution of said module utilizes data from a data store to map user subsystems and application interface, respectively, to modules providing said functionality.

10. The method according to claim 8, wherein step of executing an existing module is realized through the application's incorporation of a context-based switching mechanism whereby the application automatically invokes the appropriate, mapped module.

11. The method according to claim 8, wherein the application logs all access, execution exceptions, and performance statistics of the application and said selected modules.

12. The method according to claim 8, whereby the application provides a system-independent interface.

13. The method according to claim 12, wherein the system-independent interface comprises:
a. a collection of request schemas utilized to invoke the application's supported operations;
b. a collection of response schemas utilized to return data and error conditions to the application's clients;
c. one or more REST interfaces which mitigate the transfer of said schemas to/from the application; and
d. the abstraction of subsystem business logic from the core application into the associated subsystem processing modules.

14. The method according to claim 1, wherein the application provides a consolidated view of data from all subsystems via a web browser.

15. The method according to claim 1, wherein the application provides for the manipulation and update of data by a collection of program modules comprising:
a. selection of module encapsulating interface(s), protocol(s), and business logic for retrieving, modifying, and storing subsystem data;
b. mapping execution of said module to appropriate application interface; and
c. execution of said module.

16. The method according to claim 15, wherein said step of mapping execution of said module utilizes data from a data store to map user subsystems and application interface, respectively, to modules providing said functionality.

17. The method according to claim 15, wherein step of executing an existing module is realized through the application's incorporation of a context-based switching mechanism whereby the application automatically invokes the appropriate, mapped module.

18. The method according to claim 15, wherein the application logs all access, execution exceptions, and performance statistics of the application and said selected modules.

19. The method according to claim 15, whereby the application provides a system-independent interface.

20. The method according to claim 19, wherein the system-independent interface comprises:
a. a collection of request schemas utilized to invoke the application's supported operations;
b. a collection of response schemas utilized to return data and error conditions to the application's clients;
c. one or more REST interfaces which mitigate the transfer of said schemas to/from the application; and
d. the abstraction of subsystem business logic from the core application into the associated subsystem processing modules.
